(19) United States
(12) Patent Application Publication
(10) Pub. No.: US 2023/0142471 A1
(43) Pub. Date: May 11, 2023

(54) SKIN MATERIAL

(71) Applicant: KYOWA LEATHER CLOTH CO., LTD., Hamamatsu-shi, Shizuoka (JP)

(72) Inventors: Yasuaki SATO, Hamamatsu-shi (JP); Yutaka SHIGENOBU, Hamamatsu-shi (JP)

(73) Assignee: KYOWA LEATHER CLOTH CO., LTD., Hamamatsu-shi, Shizuoka (JP)

(21) Appl. No.: 17/909,902

(22) PCT Filed: Nov. 9, 2020
(86) PCT No.: PCT/JP2020/041661

§ 371 Date: Sep. 7, 2022

(30) Foreign Application Priority Data
Mar. 11, 2020 (JP) 2020-042116

(51) Int. Cl. B32B 27/08; B32B 5/18; B32B 27/06; B32B 27/32

(52) U.S. Cl. CPC B32B 27/08; B32B 5/18; B32B 27/32; B32B 27/065; B32B 2307/54; B32B 2307/536; B32B 2307/732; B32B 2605/003

(57) ABSTRACT

A skin material that achieves both of a cushion-like sensation and a rupture property at low temperature environments, including: a skin layer including an olefin-based resin, an intermediate layer including a polypropylene resin, and a foam layer including an olefin-based resin, in this order.

### TECHNICAL FIELD

The present invention relates to a skin material.

### BACKGROUND ART

Automobile interior parts, such as instrument panels, door parts, and seats, include an airbag for ensuring the safety of the driver and passengers. Upon automobile collision, the airbag expands and push open the cover of the airbag housing portion, whereby the airbag deploys. There are cases in which a hole or a slit is provided in the cover of the airbag housing portion so as to facilitate deployment of the airbag upon automobile collision. Since it is not desirable that the hole or the slit appears on the outer appearance of the automobile interior parts, the hole or the slit is covered with a skin material made of a resin. An example of the skin material is a laminate in which a foam layer and a skin layer are adhered to each other, and imparts a high-quality appearance to the automobile interior with tuned flexibility of the foam layer and tuned texture and designed of the skin layer.

For example, Patent Document 1 discloses a laminate of a polyolefin-based resin foam (A) and a skin (E), in which the polyolefin resin foam (A) includes 30 to 60% by mass of polypropylene resin (B), 1 to 20% by mass of polyethylene-based resin (C), and at least 30% by mass of thermoplastic elastomer-based resin (D) in 100% by mass of polyolefin-based resins configuring the polyolefin-based resin foam (A).

### PRIOR ART DOCUMENT

### Patent Document

Patent Document 1: Japanese Patent Application Laid-open No. 2016-155344

### SUMMARY OF INVENTION

### Problem to be Solved by Invention

The skin material covering an airbag housing portion needs to rupture when the skin material receives the pressure of airbag expansion, in order not to inhibit airbag deployment. However, a laminate of a foam layer and a skin layer may have a difficulty in achieving a rupture property and flexibility or a cushion-like sensation at the same time. For example, when the expansion ratio of the foam layer is increased in order to improve the cushion-like sensation, the laminate may be unable to easily rupture at low-temperature environments.

Embodiments of the present disclosure have been devised in view of the foregoing circumstances. An object of an embodiment of the present disclosure is to provide a skin material that achieves both of a cushion-like sensation and a rupture property at low temperature environments. Thus, a problem to be solved by an embodiment of the present disclosure is to achieve the object.

### Means for Solving the Problem

Specific means for solving the problem include the following aspects.

<1> A skin material, including, in this order: a skin layer including an olefin-based resin, an intermediate layer including a polypropylene resin, and a foam layer including an olefin-based resin.

<2> The skin material according to <1>, wherein the thickness of the intermediate layer is from 0.01 mm to 0.20 mm.

<3> The skin material according to <1> or <2>, wherein the expansion ratio of the foam layer is a factor of from 15 to 30, and the thickness of the foam layer is from 3.0 mm to 5.0 mm.

<4> The skin material according to any one of <1> to <3>, wherein the thickness of the skin layer is from 0.3 mm to 0.8 mm.

<5> The skin material according to any one of <1> to <4>, wherein the tensile elongation at break of a laminate of the skin layer and the intermediate layer is within a range of from 100% to 600% at a temperature of -30° C.

<6> The skin material according to any one of <1> to <5>, wherein, when a stack consisting of two sheets of the skin material is prepared and measured, the Shore A hardness thereof is less than 68.

<7> The skin material according to any one of <1> to <6>, wherein the skin material is a skin material for use in an instrument panel of an automobile.

### Advantageous Effect of Invention

According to an embodiment of the present disclosure, a skin material that achieves both of a cushion-like sensation and a rupture property at low temperature environments can be provided.

### BRIEF DESCRIPTION OF THE DRAWINGS

FIG. 1 is a cross-sectional view illustrating one example of embodiments of the skin material.

FIG. 2 is a cross-sectional view illustrating another example of embodiments of the skin material.

### MODES FOR CARRYING OUT THE INVENTION

Embodiments according to the present disclosure are described below. These descriptions and Examples are intended to illustrate embodiments, and do not limit the scope of the embodiments.

In the present disclosure, any numerical range expressed using “to” refers to a range that includes the values indicated before and after “to” as the minimum and maximum values, respectively.

For numerical ranges described in a stepwise manner in the present disclosure, the upper limit value or the lower limit value of one numerical range may be replaced by the upper limit value or the lower limit value of another numerical range in the stepwise description. The upper limit value or the lower limit value of any numerical range described in the present disclosure may also be replaced by a value described in Examples.

For each component in the present disclosure, there may be two or more substances that correspond to the component. In a case in which plural substances corresponding to a component of interest are present in a composition, the amount of the component in the composition described in the present disclosure means the total amount of the plural substances present in the composition, unless otherwise specified.

In the present disclosure, the term, “machine direction”, means a longitudinal direction of a membrane, film, or a sheet that has been produced to have an elongate shape, and the term, “width direction”, means a direction orthogonal to the “machine direction”. In the present disclosure, the “machine direction” may be abbreviated to “MD”, and the “width direction” is also referred to as the “transverse direction” (TD).

In the present disclosure, when the thickness of the skin material or the thickness of any of the layers configuring the skin material is described, the thickness refers to an average thickness. The average thickness is the arithmetic average value of the thicknesses at ten locations of the layer of interest. The thickness of a layer can be measured using a dial gauge. When the thickness of one layer is measure in a state in which plural layers are superposed one on another, the thickness may be measured by observing a cross-section thereof, using a microscope.

### Skin Material

The skin material of the present disclosure includes, in this order, a skin layer including an olefin-based resin, an intermediate layer including a polypropylene resin, and a foam layer including an olefin-based resin. The skin material of the present disclosure may further have a layer other than these three layers.

The skin material of the present disclosure is used, for example, as an automobile interior part. The skin material of the present disclosure is suitable as a covering material that covers an airbag housing portion provided in an automobile interior part such as an instrument panel, a door part, or a seat. The skin material of the present disclosure is used, for example, as a skin material adhered to a substrate that forms a cover of an airbag housing portion.

The skin material of the present disclosure is described below with reference to drawings. Constituent elements designated by the same reference character in the drawings refer to the same constituent element. In the figures, the sizes of members are conceptual sizes, and the relative relationship among the sizes of the members is not limited thereto. The configuration of the skin material of the present disclosure is not limited to the configurations illustrated in the drawings.

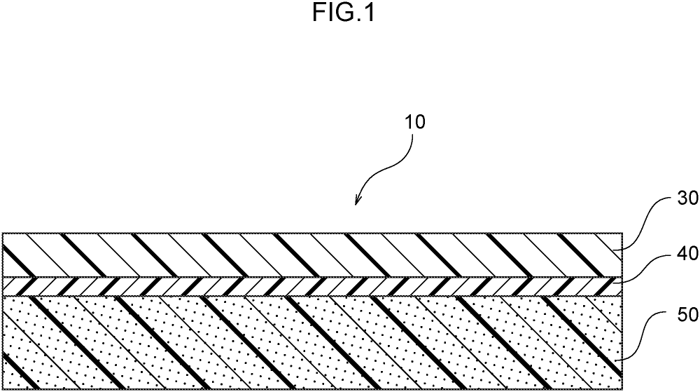

FIG. 1 is a cross-sectional view illustrating one example of embodiments of the skin material. The skin material 10 includes a skin layer 30, an intermediate layer 40, and a foam layer 50. The skin layer 30 is disposed at one side of the intermediate layer 40, and the foam layer 50 is disposed at the other side of the intermediate layer 40.

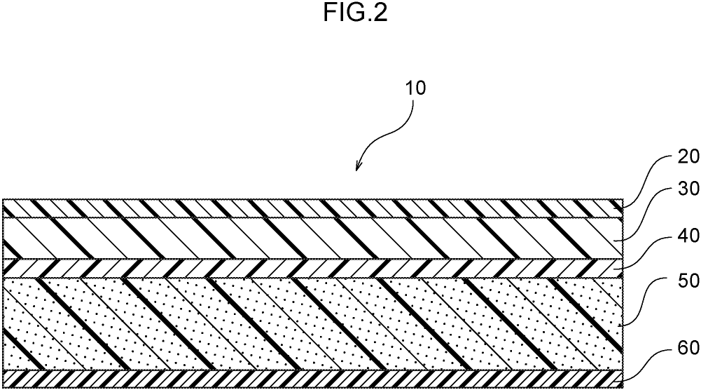

FIG. 2 is a cross-sectional view illustrating another example of embodiments of the skin material. The skin material 10 includes a surface treatment layer 20, a skin layer 30, an intermediate layer 40, a foam layer 50, and an adhesion layer 60. The surface treatment layer 20 is disposed at one side of the skin layer 30 that is a side opposite to a side facing the intermediate layer 40. The adhesion layer 60 is disposed at one side of the foam layer 50 that is a side opposite to a side facing the intermediate layer 40.

The skin layer 30 includes a first olefin-based resin. The intermediate layer 40 includes a polypropylene resin. The foam layer 50 includes a second olefin-based resin. The first olefin-based resin and the second olefin-based resin may be the same type of olefin-based resin, or may be different types of olefin-based resins.

The skin material 10 includes the intermediate layer 40 disposed between the skin layer 30 and the foam layer 50, and this configuration enables achievement of both of a cushion-like sensation and a rupture property at low temperature environments (for example, a temperature of -30° C.). The rupture property of the skin material 10 means that the skin material 10 ruptures, without excessive elongation of the skin material 10 or inter-layer separation in the skin material 10, when the skin material 10 receives a pressure. The pressure that causes rupture of the skin material 10 is, for example, the pressure applied when the rupture portion of the ruptured base material pushes the skin material 10, in a case in which the base material that forms a cover for the airbag housing portion ruptures during deployment of an automobile airbag.

It is presumable that the mechanism through which the skin material 10 achieves both of a cushion-like sensation and a rupture property at low temperature environments is as follows.

Increasing the expansion ratio of the foam layer is known as a conventional means for improving the cushion-like sensation of the skin material. However, there is a tendency that an increased expansion ratio of the foam layer would result in a decreased delamination strength between the foam layer and a layer adjacent thereto. Because of this, there are cases in which delamination occurs between the foam layer and a layer adjacent thereto when a skin material receives a pressure, and the skin material does not rupture. This phenomenon is conspicuous at low temperatures (for example, a temperature of -30° C.).

In contrast, since the skin material 10 has a configuration in which the intermediate layer 40 includes a polypropylene resin, and in which the foam layer 50 includes an olefin-based resin, the intermediate layer 40 and the foam layer 50 melt-mix with each other at the interface therebetween when bonding the intermediate layer 40 and the foam layer 50 by means of application of heat and pressure, as a result of which the delamination strength between the foam layer 50 and a layer adjacent thereto (that is, the intermediate layer 40) improves. Thus, the skin material 10 is less prone to delamination between the foam layer 50 and a layer adjacent thereto upon pressure application, even at low temperature environments, and the skin material 10 has an excellent rupture property.

Further, since the skin material 10 includes the intermediate layer 40 containing a polypropylene resin, the skin material 10 has a relatively low tendency to elongate at low-temperature environments, and tends to rupture when receiving a pressure.

The components and functions of the respective layers included in the skin material of the present disclosure are described in detail below. In the descriptions provided below, reference characters are omitted.

### Skin Layer

The skin layer includes an olefin-based resin. Examples of the olefin-based resin include olefin-based thermoplastic elastomers (TPOs) including polyolefins and ethylene-α-olefin copolymers; and thermoplastic resins that include an olefin, such as ethylene or propylene, as a main component (specifically, polyethylene, polypropylene, and the like). Among them, TPOs are preferable from the viewpoints of, for example, moldability, heat resistance, cold resistance, and light weight.

The skin layer may include a resin other than the olefin-based resin. The mass proportion of the olefin-based resin in the total resin components is preferably 90% by mass or more, more preferably 95% by mass or more, and still more preferably 100% by mass.

The skin layer may include a coloring agent. The coloring agent may be selected from pigments and dyes. Pigments are preferable from the viewpoint of durability.

The mass proportion of the olefin-based resin in the total mass of the skin layer is preferably 70% by mass or more, more preferably 80% by mass or more, and still more preferably 90% by mass.

The thickness of the skin layer is preferably from 0.3 mm to 0.8 mm, and more preferably from 0.4 mm to 0.7 mm, from the viewpoints of tensile strength, moldability, and texture.

### Intermediate Layer

The intermediate layer includes a polypropylene resin. In the present disclosure, the scope of the polypropylene resin encompasses homopolymers, random copolymers, as well as block copolymers.

The intermediate layer may include a resin other than the polypropylene resin. The mass proportion of the polypropylene resin in the total resin components is preferably 90% by mass or more, more preferably 95% by mass or more, and still more preferably 100% by mass. Examples of a resin, other than the polypropylene resin, that may be included in the intermediate layer include polyethylene resins.

Polypropylene resins have a glass transition temperature that is at or around 0° C., and, therefore, polypropylene resins have a relatively low tendency to elongate in low-temperature environments. The skin material of the present disclosure has a relatively low tendency to elongate at low-temperature environments and tends to rupture when the skin material receives a pressure, due to inclusion of the intermediate layer including a polypropylene resin.

In the skin material of the present disclosure, the intermediate layer includes a polypropylene resin, and the foam layer includes an olefin-based resin; due to this configuration, the intermediate layer and the foam layer melt-mixes at the interface between the intermediate layer and the foam layer when these layers are bonded by application of heat and pressure, as a result of which delamination strength between the foam layer and a layer adjacent thereto (that is, the intermediate layer) is improved. For this reason, the skin material of the present disclosure is less prone to delamination between the foam layer and a layer adjacent thereto when the skin material receives a pressure, and the skin material of the present disclosure has an excellent rupture property.

The thickness of the intermediate layer is preferably at least 0.01 mm or more, and more preferably 0.05 mm or more, from the viewpoint of connecting the skin layer and the foam layer.

However, it is preferable that the thickness of the intermediate layer is not excessively large, from the viewpoint of reducing delamination between the intermediate layer and the foam layer. Polypropylene resins exhibit a relatively large stress at low-temperature environments. Therefore, when the intermediate layer including a polypropylene resin is excessively thick, delamination between the intermediate layer and the foam layer may occur when the skin material receives a pressure.

The thickness of the intermediate layer is preferably 0.20 mm or less, and more preferably 0.15 mm or less, from the foregoing viewpoints.

The intermediate layer may include a coloring agent. The coloring agent may be selected from pigments and dyes. Pigments are preferable from the viewpoint of durability.

The mass proportion of the polypropylene resin in the total mass of the intermediate layer is preferably 70% by mass or more, more preferably 80% by mass or more, and still more preferably 90% by mass.

### Foam Layer

The foam layer includes an olefin-based resin. Examples of the olefin-based resin include olefin-based thermoplastic elastomers (TPOs) including polyolefins and ethylene-α-olefin copolymers; and thermoplastic resins that include an olefin, such as ethylene or propylene, as a main component (specifically, polyethylene, polypropylene, and the like). Among them, polypropylene is preferable from the viewpoints of heat resistance and light weight.

The foam layer may include a resin other than the olefin-based resin. The mass proportion of the olefin-based resin in the total resin components is preferably 90% by mass or more, more preferably 95% by mass or more, and still more preferably 100% by mass. Examples of a resin, other than the olefin-based resin, that may be included in the foam layer include antioxidants such as phenol-based resins.

The foam layer may have either a configuration in which air bubbles are continuous to one another or a configuration in which air bubbles are independent from one another.

The expansion ratio of the foam layer is preferably a factor of 15 to 30, and more preferably a factor of from 15 to 20, from the viewpoints of moldability, a cushion-like property, and a skin material rupture property.

The expansion ratio is a physical property value obtained by measuring the mass of a prescribed volume of the foam, and expressed in terms of the unit, “liter/kg”, which is indicated as a “factor”.

The thickness of the foam layer is preferably from 3.0 mm to 5.0 mm, and more preferably from 3.0 mm to 4.0 mm, from the viewpoints of moldability and a cushion-like sensation.

The foam layer may include a coloring agent. The coloring agent may be selected from pigments and dyes. Pigments are preferable from the viewpoint of durability.

The mass proportion of the olefin-based resin in the total mass of the foam layer is preferably 70% by mass or more, more preferably 80% by mass or more, and still more preferably 90% by mass.

### Surface Treatment Layer

The skin material of the present disclosure may include a surface treatment layer, for the purposes of, for example, protection of the skin layer, improvement of the durability of the skin material, and improvement of the texture of the skin material. One examples of embodiments of the surface treatment layer is a layer provided on one side of the skin layer (also referred to as the “first side of the skin layer”) that is opposite to a side facing the intermediate layer.

The surface treatment layer preferably includes a urethane resin, a vinyl chloride resin, an acrylic resin, a fluororesin, or the like. It is preferable that the surface treatment layer includes a urethane resin, from the viewpoints of wear resistance and texture.

The surface treatment layer may include a crosslinking agent, an organic filler, an inorganic filler (such as silica particles), a sliding agent, a flame retardant, an antioxidant, an antistatic, or the like, in addition to a resin.

The thickness of the surface treatment layer is preferably from 2.0 µm to 6.0 µm.

### Adhesion Layer

The skin material of the present disclosure may include an adhesion layer configured to adhere the skin material to a surface of a molded article on which the skin material is to be disposed. One example of embodiments of the adhesion layer is a layer that is provided on one side of the foam layer (also referred to as the first side of the foam layer) that is opposite to a side facing the intermediate layer.

The adhesion layer preferably includes an olefin resin, a urethane resin, or the like. It is preferable that the adhesion layer includes an olefin resin, from the viewpoint of property of adhering to a surface of a molded article.

The thickness of the adhesion layer is preferably from 5 µm to 70 µm.

### Property of Skin Material

The thickness of the skin material of the present disclosure is preferably from 3.30 mm to 6.00 mm, and more preferably from 3.45 mm to 4.90 mm, from the viewpoints of moldability, a cushion-like sensation, and a skin material rupture property.

The Shore A hardness (ISO868: 2003) of the skin material of the present disclosure is preferably less than 68, and more preferably 65 or less, from the viewpoint of providing an excellent cushion-like sensation. The Shore A hardness mentioned herein is a measured value obtained by stacking two sheets of the skin material and performing a compression test from the skin layer side.

When a laminate is prepared by superposing the skin layer and the intermediate layer of the skin material of the present disclosure one on the other, the tensile elongation at break of the laminate at a temperature of -30° C. is preferably in the range of from 100% to 600% with respect to both of MD and TD, from the viewpoint of rupture property of the skin material.

### Method of Producing Skin Material

An example of methods for producing the skin material of the present disclosure is a production method including: providing the skin layer, the intermediate layer, and the foam layer; superposing these layers in the order of the skin layer / the intermediate layer / the foam layer; and performing lamination.

The skin layer is preferably produced by extrusion molding or calender molding. It is preferable that the skin layer is produced by extrusion molding, from the viewpoint of capability to produce a sheet having an appropriate thickness without performing a bonding operation.

The intermediate layer is preferably produced by extrusion molding or calender molding. It is preferable that the intermediate layer is produced by extrusion molding, from the viewpoint of capability to produce a sheet having an appropriate thickness without performing a bonding operation.

The foam layer can be produced by a known foam molding, such as press foaming, normal pressure post-foaming, injection foaming, extrusion foaming, or foam blowing. Examples of foam agents include organic foaming agents such as azodicarbonamide, N,N′-dinitropentamethylenetetramine, and p,p′-oxybis(benzenesulfonyl hydrazide); and inorganic foaming agents such as sodium hydrogen carbonate, ammonium carbonate, ammonium hydrogen carbonate, and calcium azide.

The surface treatment layer is preferably formed on the first side of the skin layer by a coating method. The surface treatment layer may be formed on the skin layer prior to lamination of the skin layer, the intermediate layer, and the foam layer, or may be formed on the skin layer after the lamination.

The adhesion layer is preferably formed on the foam layer by a coating method, after the skin layer, the intermediate layer, and the foam layer are laminated together.

### EXAMPLES

Embodiments of the invention are described in detail below with reference to Examples. However, embodiments of the invention are not limited to the Examples. In the descriptions provided below, “part(s)” and “%” are based on mass, unless otherwise specified.

### Example 1

### Step 1: Formation of Skin Layer

10 parts of pigment (carbon black) were added to 90 parts of an olefin-based thermoplastic elastomer (Mitsui Chemicals, Inc., 8030NH), and a skin layer was formed by an extrusion method while the mixture was heated to 220° C. The thickness of the skin layer was set to 0.4 mm.

### Step 2: Formation of Intermediate Layer

10 parts of a pigment (carbon black) was added to 90 parts of a polypropylene resin (Prime Polymer Co., Ltd., PRIME POLYPRO E701G, block polypropylene), and an intermediate layer was formed by an extrusion method while the mixture was heated to 220° C. The thickness of the intermediate layer was set to 0.05 mm.

### Step 3: Preparation of Foam Layer

A polyolefin-based resin foam having an expansion ratio of a factor of 15 and a thickness of 3.0 mm (Toray Industries, Inc., TORAYPEF) was purchased, and used as a foam layer.

### Step 4: Formation of Surface Treatment Layer

12 parts of silica particles (Nihon Silica Kogyo Kabushiki Kaisha, NIPSIL E220) was added to 100 parts of a urethane resin (DIC Corporation, CRISVON NY-329), and the mixture was diluted with a solvent, to prepare a coating liquid.

The first side of the skin layer (a side that is opposite to a side facing the intermediate layer) was subjected to corona treatment to adjust the wettability to at least 40 mN/m. Thereafter, the coating liquid was applied thereto using a gravure print roll, and dried at a temperature of 100° C. for 3 minutes, to form a surface treatment layer having a thickness of 4.0 µm.

### Step 5: Lamination

The skin layer and the intermediate layer were heated, layers were disposed one on another in the order of skin layer / intermediate layer / foam layer, and laminate embossing was performed using an emboss roll while the skin layer was made to contact a squeeze roll. The laminate embossing was performed with a surface temperature of the skin layer of 180° C. and a velocity of 6 m/min.

### Step 6: Formation of Adhesion Layer

An olefin-based pre-coat agent (Sunstar-Engineering Inc., Penguin Cement) was applied to the first side of the foam layer (a side opposite to a side facing the intermediate layer), using a Comma Reverse Coater, and dried at a temperature of 100° C., to form an adhesion layer having a thickness of 30 µm.

Through the foregoing steps, a skin material of Example 1 was obtained.

### Example 2

A skin material was prepared in the same manner as that in Example 1, except that the thickness of the skin layer was changed to 0.7 mm, and that the thickness of the intermediate layer was changed to 0.15 mm.

### Example 3

A skin material was prepared in the same manner as that in Example 1, except that the foam layer was replaced by a foam layer having an expansion ratio of a factor of 20 and a thickness of 4.0 mm.

### Example 4

A skin material was prepared in the same manner as that in Example 2, except that the foam layer was replaced by a foam layer having an expansion ratio of a factor of 20 and a thickness of 4.0 mm.

### Example 5

A skin material was prepared in the same manner as that in Example 1, except that the polypropylene resin (PRIME POLYPRO E701G) was replaced by another polypropylene resin (Prime Polymer Co., Ltd., PRIME POLYPRO B211WA, random polypropylene) in the formation of the intermediate layer in Step 2.

### Example 6

A skin material was prepared in the same manner as that in Example 5, except that the thickness of the skin layer was changed to 0.7 mm, and that the thickness of the intermediate layer was changed to 0.15 mm.

### Example 7

A skin material was prepared in the same manner as that in Example 5, except that the foam layer was replaced by a foam layer having an expansion ratio of a factor of 20 and a thickness of 4.0 mm.

### Example 8

A skin material was prepared in the same manner as that in Example 6, except that the foam layer was replaced by a foam layer having an expansion ratio of a factor of 20 and a thickness of 4.0 mm.

### Comparative Example 1

A skin material was prepared in the same manner as that in Example 1, except that the thickness of the skin layer was changed to 0.6 mm, that the intermediate layer was not provided, and that the foam layer was replaced by a foam layer having an expansion ratio of a factor of 10 and a thickness of 4.0 mm.

### Comparative Example 2

A skin material was prepared in the same manner as that in Comparative Example 1, except that the foam layer was replaced by a foam layer having an expansion ratio of a factor of 20 and a thickness of 4.0 mm.

### Comparative Example 3

A skin material was prepared in the same manner as that in Example 1, except that the thickness of the skin layer was changed to 0.5 mm, that the polypropylene resin (PRIME POLYPRO E701G) was replaced by a polyethylene resin (Prime Polymer Co., Ltd., ULTZEX2022L) in Step 2 to form an intermediate layer having a thickness of 0.1 mm, and that the foam layer was replaced by a foam layer having an expansion ratio of a factor of 20 and a thickness of 4.0 mm.

### Comparative Example 4

A skin material was prepared in the same manner as that in Example 1, except that the skin layer was replaced by a skin layer made of the same material as that of the intermediate layer of Example 1 and having a thickness of 0.6 mm, that the intermediate layer was not provided, and that the foam layer was replaced by a foam layer having an expansion ratio of a factor of 20 and a thickness of 4.0 mm.

### Comparative Example 5

A skin material was prepared in the same manner as that in Example 1, except that the skin layer was replaced by a skin layer made of the same material as that of the intermediate layer of Example 5 and having a thickness of 0.6 mm, that the intermediate layer was not provided, and that the foam layer was replaced by a foam layer having an expansion ratio of a factor of 20 and a thickness of 4.0 mm.

### Evaluation of Performance

### Shore a Hardness and Cushion-Like Sensation

The measurement of Shore A hardness was performed using a type A durometer in accordance with ISO868:2003. Two sheets of the skin material that had been cut into a 100 mm × 100 mm size were superposed one on the other, compressed from the surface treatment layer side, and the value after 15 seconds was read. The value of the Shore A hardness was used as an index of the cushion-like sensation, and graded into the following ranks.
A: less than 68 (softer than Comparative Example 1)
B: from 68 to 70 (equivalent to Comparative Example 1)
C: more than 70 (harder than Comparative Example 1)

### Delamination Strength

The skin material was cut into a size of 150 mm × 25 mm with the long sides thereof corresponding to the MD or TD, whereby a test piece was obtained. The test piece was left to stand at a temperature of -30° C. for 10 minutes, and then subjected to a 180 ° delamination test at a temperature of -30° C. and a test velocity of 500 mm/min., to measure the delamination strength (N / 25 mm) between the intermediate layer and the foam layer (or, between the skin layer and the foam layer in the case of a skin material having no intermediate layer).

### Stress-Strain Curve

The foam layer was removed from the skin material, and the skin material was stamped into a dumbbell type 2 shape with the MD or TD corresponding to the tensile direction, whereby a test piece was obtained. The test piece was left to stand at a temperature of -30° C. for 10 minutes, and then subjected to a tensile test at a temperature of -30° C. and a test velocity of 500 mm/min., to obtain the maximum stress (N) and the elongation when the test piece broke (tensile elongation at break, %).

### Rupture Property of Skin Material

A 400 mm × 300 mm-sized polypropylene sheet having a thickness of 2.9 mm was prepared as a base material. Cutting to a depth of 2.45 mm was performed, in the shape of the alphabet “H”, at a 200 mm × 100 mm-sized region at the central portion of the base material.

A chloroprene-based adhesive was applied to a side of the cut base material that is opposite to a side having the cut, and the skin material was adhered to the base material with the side of the base material to which the adhesive had been applied and the adhesion layer of the skin material being allowed to face each other, whereby a test piece was obtained.

A test machine for simulating deployment of an airbag was prepared. The test machine includes a substantially rectangular-parallelepiped-shaped head (having a height of about 7.5 cm, a width of about 7.5 cm, and a length of about 17 cm), members configured to fix a test piece onto the head, and a mechanism configured to elevate the head, and the test machine is a machine configured to rupture the test piece by elevating the head.

The test machine and the test piece were left to stand at a temperature of -30° C. for 10 minutes, and then the test piece was fixed to the test machine in a prescribed manner. At the time of fixing, the base-material-side of the test piece was allowed to face the top face of the head, and the test piece was placed such that the top face of the head was positioned at the central portion of the region of the base material on which the cutting had been performed.

The test piece was ruptured by elevating the head of the test machine to apply a pressure of 0.4 MPa, at a temperature of -30° C. The state of the rupture of the skin material was observed with the naked eyes, and was graded into the following ranks. Rank A indicates a practically non-problematic level.
A: The skin material ruptures, and the rupture is clear (the rupture edge has an ordered shape).
B: The skin material ruptures, but the rupture is rough (the rupture edge has an unordered shape).
C: The skin material ruptures, but delamination occurs at an interlayer interface between any two adjacent layers among the layers from the skin layer to the foam layer.
D: The skin material ruptures, but scattering of the skin material occurs.
E: The skin material does not rupture

TABLE 1

| | | | | Examples | | | | | | | | Comparative Examples | | | | |
|---|---|---|---|---|---|---|---|---|---|---|---|---|---|---|---|---|
| | | | | 1 | 2 | 3 | 4 | 5 | 6 | 7 | 8 | 1 | 2 | 3 | 4 | 5 |
| Configuration | Skin Layer | Resin | | TPO | | | | | | | | TPO | | | Block PP | Random PP |
| | | Thickness (mm) | | 0.4 | 0.7 | 0.4 | 0.7 | 0.4 | 0.7 | 0.4 | 0.7 | 0.6 | | 0.5 | 0.6 | |
| | Intermediate Layer | Resin | | Block PP | | | | Random PP | | | | - | | PE | - | |
| | | Thickness (mm) | | 0.05 | 0.15 | 0.05 | 0.15 | 0.05 | 0.15 | 0.05 | 0.15 | | | 0.1 | | |
| | Foam Layer | Resin | | PP | | | | | | | | PP | | | | |
| | | Expansion Ratio (factor) | | 15 | | 20 | | 15 | | 20 | | 10 | 20 | | | |
| | | Thickness (mm) | | 3.0 | | 4.0 | | 3.0 | | 4.0 | | 4.0 | 4.0 | | | |
| Evaluation | Shore A Ha ardness | | | 55 | 67 | 53 | 64 | 55 | 65 | 53 | 60 | 68 | 52 | 56 | 77 | 69 |
| | Delamination n Strength -30° C. N / 25 mm | | MD | 28 | 29 | 24 | 25 | 26 | 29 | 22 | 25 | 30 | 18 | 23 | 28 | 29 |
| | | | TD | 26 | 24 | 22 | 20 | 24 | 24 | 20 | 20 | 26 | 17 | 22 | 22 | 31 |
| | S-S -30° C. Without Foam Layer | Stress (N) | MD | 177 | 251 | 177 | 251 | 190 | 282 | 190 | 282 | 220 | 220 | 223 | 280 | 344 |
| | | | TD | 203 | 227 | 203 | 227 | 195 | 237 | 195 | 237 | 187 | 187 | 232 | 300 | 352 |
| | | Elongation at Break (%) | MD | 472 | 292 | 472 | 292 | 543 | 362 | 543 | 362 | 789 | 789 | 789 | 75 | 132 |
| | | | TD | 572 | 110 | 572 | 110 | 589 | 180 | 589 | 180 | 712 | 712 | 789 | 4 | 6 |
| | Cushion-like Sensation | | - | A | A | A | A | A | A | A | A | B | A | A | C | B |
| | Rupture Proper Material at rty of Skin -30° C. | | - | A | A | A | A | A | A | A | A | A | C | B | D | D |

Comparative Example 1 corresponds to a conventional product that is a laminate of a foam layer and a skin layer.

Comparative Example 2 has a configuration that is similar to that of Comparative Example 1, but has a higher expansion ratio of the foam layer than that in Comparative Example 1.

Based on the comparison between Comparative Example 1 and Comparative Example 2, it is seen that a higher expansion ratio of the foam layer provides a better cushion-like sensation, and that a higher expansion ratio of the foam layer provides a lower delamination strength between the skin layer and the foam layer.

Comparative Example 3 has a configuration that is similar to that of Comparative Example 2, but in which the skin layer (0.6 mm) in Comparative Example 2 is divided into a skin layer (0.5 mm) and an intermediate layer (0.1 mm) including a polyethylene resin. Comparative Example 3 exhibited a cushion-like sensation as good as that of Comparative Example 2, but has an improved rupture property of the skin material in the low-temperature environment compared to Comparative Example 2. However, Comparative Example 3 has a greater TD stress and a greater tensile elongation at break in the low-temperature environment than those of Comparative Example 1, and Comparative Example 3 has an inferior rupture property of the skin material in the low-temperature environment compared to Comparative Example 1.

Comparative Example 4 and 5 have configurations that are similar to that of Comparative Example 2, but in which the TPO as the skin layer forming resin used in Comparative Example 2 is replaced by a block PP or a random PP. In Comparative Examples 4 and 5, the skin layer forming resins are a block PP and a random PP, respectively, and the foam layer forming resin is an olefin-based resin. It is conceivable that, due to the foregoing configurations, the interface between the skin layer and the foam layer melt-mixed at the time of bonding the skin layer and the foam layer by means of application of heat and pressure, as a result of which the delamination strength between the skin layer and the foam layer improved as compared to that of Comparative Example 2. However, since Comparative Examples 4 and 5 exhibited an extremely small tensile elongation at break in the low-temperature environment, scattering of the skin material occurred.

Examples 1 to 8 are skin materials in which the expansion ratio of the foam layer is higher than that of Comparative Example 1 and in which an intermediate layer including a polypropylene resin is provided between the skin layer and the foam layer. Example 1 to 8 have an expansion ratio of the foam layer that is higher than that of Comparative Example 1, and thus exhibited a better cushion-like sensation than that of Comparative Example 1.

Although Examples 1 to 8 have an expansion ratio of the foam layer that is higher than that of Comparative Example 1, the delamination strength between the foam layer and the layer adjacent thereto is comparable to that of Comparative Example 1, due to the fact that the intermediate layer including a polypropylene resin is disposed. Further, Examples 1 to 8 exhibited a smaller tensile elongation at break in the low-temperature environment than that of Comparative Example 1, as a result of which Examples 1 to 8 exhibited a rupture property of the skin material in the low-temperature environment that is comparable to that of Comparative Example 1.

Explanation of Reference Characters

| | |
|---|---|
| 10 | Skin Material |
| 20 | Surface Treatment Layer |
| 30 | Skin Layer |
| 40 | Intermediate Layer |
| 50 | Foam Layer |
| 60 | Adhesion Layer |

The disclosure of Japanese Patent Application No. 2020-042116, filed Mar. 11, 2020, is incorporated herein by reference.

All publications, patent applications, and technical standards mentioned in this specification are herein incorporated by reference to the same extent as if each individual publication, patent application, or technical standard was specifically and individually indicated to be incorporated by reference.

1. A skin material, comprising, in this order:
a skin layer including an olefin-based resin;
an intermediate layer including a polypropylene resin; and
a foam layer including an olefin-based resin.

2. The skin material according to claim 1, wherein a thickness of the intermediate layer is from 0.01 mm to 0.20 mm.

3. The skin material according to claim 1, wherein an expansion ratio of the foam layer is a factor of from 15 to 30, and a thickness of the foam layer is from 3.0 mm to 5.0 mm.

4. The skin material according to claim 1, wherein a thickness of the skin layer is from 0.3 mm to 0.8 mm.

5. The skin material according to claim 1, wherein a tensile elongation at break of a laminate of the skin layer and the intermediate layer is within a range of from 100% to 600 % at a temperature of -30° C.

6. The skin material according to 5,claim 1, wherein, when a stack consisting of two sheets of the skin material is prepared and measured, a Shore A hardness thereof is less than 68.

7. An instrument panel of an automobile, comprising the skin material according to .claim 1.
